(19) United States
(12) Patent Application Publication
(10) Pub. No.: US 2025/0392500 A1
(43) Pub. Date: Dec. 25, 2025

(54) MACHINE LEARNING ENHANCED PILOTLESS RADIO TRANSMISSION WITH SPATIAL MULTIPLEXING

(71) Applicant: Nokia Solutions and Networks Oy, Espoo (FI)

(72) Inventors: Dani Johannes KORPI, Espoo (FI); Mikko Johannes HONKALA, Espoo (FI); Janne Matti Juhani HUTTUNEN, Espoo (FI); Mikko Aleksi UUSITALO, Espoo (FI)

(21) Appl. No.: 18/880,319

(22) PCT Filed: Jul. 4, 2022
(86) PCT No.: PCT/EP2022/068387

§ 371 Date: Dec. 31, 2024

(51) Int. Cl. H04L 25/03; H04B 7/0452; H04B 7/06

(52) U.S. Cl. CPC H04L 25/03165; H04B 7/0452; H04B 7/0697

(57) ABSTRACT

Machine learning enhanced pilotless radio transmission with spatial multiplexing is disclosed. Parallel transmission bit streams are obtained at a radio transmitter device. The radio transmitter device modulates the obtained parallel transmission bit streams for a pilotless multiple-input and multiple-output (MIMO) transmission over a radio channel based on transmission bit stream-specific customized constellation shapes. The customized constellation shapes are generated with an end-to-end machine learning (ML) model representing the radio transmitter device, a radio receiver device and the radio channel. The end-to-end ML model is executable to learn a separate customized constellation shape for each of the at least two parallel transmission bit streams.

### TECHNICAL FIELD

The disclosure relates generally to communications and, more particularly but not exclusively, to machine learning enhanced pilotless radio transmission with spatial multiplexing.

### BACKGROUND

Recently, various deep learning-based solutions have been proposed for enhancing physical layer performance of wireless communication systems. For example, deep learning may be used for implementing tasks for which an optimal solution is very complex or unknown.

However, many of the solutions thus far have only considered a single-antenna scenario in which data signals are not overlapping. Considering a more challenging multiple-input and multiple-output (MIMO) scenario with spatial multiplexing makes, e.g., the task of pilotless detection significantly more challenging. For example, it may not be enough to detect symbols based on a constellation, but there also needs to be a capability to separate different spatial streams.

Accordingly, at least in some situations, there may be a need for machine learning enhanced pilotless radio transmission with spatial multiplexing.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a radio transmitter device comprises at least one processor, and at least one memory including computer program code. The at least one memory and the computer program code are configured to, with the at least one processor, cause the radio transmitter device at least to perform obtaining at least two parallel transmission bit streams. The at least one memory and the computer program code are further configured to, with the at least one processor, cause the radio transmitter device at least to perform modulating the obtained at least two parallel transmission bit streams for a pilotless multiple-input and multiple-output (MIMO) transmission over a radio channel based on transmission bit stream-specific customized constellation shapes. The customized constellation shapes are generated with an end-to-end machine learning (ML) model representing the radio transmitter device, a radio receiver device and the radio channel. The end-to-end ML model is executable to learn a separate customized constellation shape for each of the at least two parallel transmission bit streams.

In an example embodiment, alternatively or in addition to the above-described example embodiments, the end-to-end ML model is further executable to learn at least one customized constellation shape of the customized constellation shapes via learning at least two transformations mapping from a predefined constellation shape to the respective customized constellation shape.

In an example embodiment, alternatively or in addition to the above-described example embodiments, the end-to-end ML model is further executable to construct a final constellation shape of the respective customized constellation shape as a linear combination of the learned at least two transformations.

In an example embodiment, alternatively or in addition to the above-described example embodiments, the predefined constellation shape comprises a quadrature amplitude modulation (QAM) constellation shape.

In an example embodiment, alternatively or in addition to the above-described example embodiments, the end-to-end ML model is further executable to learn at least one customized constellation shape of the customized constellation shapes via learning a single layer specific transformation mapping from a predefined constellation shape to the respective customized constellation shape as a single fully connected neural network.

In an example embodiment, alternatively or in addition to the above-described example embodiments, the end-to-end ML model is further executable to learn at least one customized constellation shape of the customized constellation shapes directly from a random initialization.

In an example embodiment, alternatively or in addition to the above-described example embodiments, the end-to-end ML model is further executable to refine at least one learned customized constellation shape via contextual information.

In an example embodiment, alternatively or in addition to the above-described example embodiments, the contextual information comprises at least one of an expected signal-to-noise ratio of a client device, a mobility level of a client device, a number of MIMO layers, a number of overlapping client devices, a model size of the radio receiver device, or one or more channel conditions.

In an example embodiment, alternatively or in addition to the above-described example embodiments, the at least one memory and the computer program code are further configured to, with the at least one processor, cause the radio transmitter device to perform training the end-to-end ML model by applying a loss comprising a constellation quality metric indicating maximum and minimum distances between two constellation points.

In an example embodiment, alternatively or in addition to the above-described example embodiments, the loss further comprises a binary cross entropy.

An example embodiment of a radio transmitter device comprises means for performing obtaining at least two parallel transmission bit streams. The means are further configured to perform modulating the obtained at least two parallel transmission bit streams for a pilotless multiple-input and multiple-output (MIMO) transmission over a radio channel based on transmission bit stream-specific customized constellation shapes. The customized constellation shapes are generated with an end-to-end machine learning (ML) model representing the radio transmitter device, a radio receiver device and the radio channel. The end-to-end ML model is executable to learn a separate customized constellation shape for each of the at least two parallel transmission bit streams.

In an example embodiment, alternatively or in addition to the above-described example embodiments, the end-to-end ML model is further executable to learn at least one customized constellation shape of the customized constellation shapes via learning at least two transformations mapping from a predefined constellation shape to the respective customized constellation shape.

In an example embodiment, alternatively or in addition to the above-described example embodiments, the end-to-end ML model is further executable to construct a final constellation shape of the respective customized constellation shape as a linear combination of the learned at least two transformations.

In an example embodiment, alternatively or in addition to the above-described example embodiments, the predefined constellation shape comprises a quadrature amplitude modulation (QAM) constellation shape.

In an example embodiment, alternatively or in addition to the above-described example embodiments, the end-to-end ML model is further executable to learn at least one customized constellation shape of the customized constellation shapes via learning a single layer specific transformation mapping from a predefined constellation shape to the respective customized constellation shape as a single fully connected neural network.

In an example embodiment, alternatively or in addition to the above-described example embodiments, the end-to-end ML model is further executable to learn at least one customized constellation shape of the customized constellation shapes directly from a random initialization.

In an example embodiment, alternatively or in addition to the above-described example embodiments, the end-to-end ML model is further executable to refine at least one learned customized constellation shape via contextual information.

In an example embodiment, alternatively or in addition to the above-described example embodiments, the contextual information comprises at least one of an expected signal-to-noise ratio of a client device, a mobility level of a client device, a number of MIMO layers, a number of overlapping client devices, a model size of the radio receiver device, or one or more channel conditions.

In an example embodiment, alternatively or in addition to the above-described example embodiments, the means are further configured to perform training the end-to-end ML model by applying a loss comprising a constellation quality metric indicating maximum and minimum distances between two constellation points.

In an example embodiment, alternatively or in addition to the above-described example embodiments, the loss further comprises a binary cross entropy.

An example embodiment of a method comprises obtaining, at a radio transmitter device, at least two parallel transmission bit streams. The method further comprises modulating, by the radio transmitter device, the obtained at least two parallel transmission bit streams for a pilotless multiple-input and multiple-output (MIMO) transmission over a radio channel based on transmission bit stream-specific customized constellation shapes. The customized constellation shapes are generated with an end-to-end machine learning (ML) model representing the radio transmitter device, a radio receiver device and the radio channel. The end-to-end ML model is executable to learn a separate customized constellation shape for each of the at least two parallel transmission bit streams.

In an example embodiment, alternatively or in addition to the above-described example embodiments, the end-to-end ML model is further executable to learn at least one customized constellation shape of the customized constellation shapes via learning at least two transformations mapping from a predefined constellation shape to the respective customized constellation shape.

In an example embodiment, alternatively or in addition to the above-described example embodiments, the end-to-end ML model is further executable to construct a final constellation shape of the respective customized constellation shape as a linear combination of the learned at least two transformations.

In an example embodiment, alternatively or in addition to the above-described example embodiments, the predefined constellation shape comprises a quadrature amplitude modulation (QAM) constellation shape.

In an example embodiment, alternatively or in addition to the above-described example embodiments, the end-to-end ML model is further executable to learn at least one customized constellation shape of the customized constellation shapes via learning a single layer specific transformation mapping from a predefined constellation shape to the respective customized constellation shape as a single fully connected neural network.

In an example embodiment, alternatively or in addition to the above-described example embodiments, the end-to-end ML model is further executable to learn at least one customized constellation shape of the customized constellation shapes directly from a random initialization.

In an example embodiment, alternatively or in addition to the above-described example embodiments, the end-to-end ML model is further executable to refine at least one learned customized constellation shape via contextual information.

In an example embodiment, alternatively or in addition to the above-described example embodiments, the contextual information comprises at least one of an expected signal-to-noise ratio of a client device, a mobility level of a client device, a number of MIMO layers, a number of overlapping client devices, a model size of the radio receiver device, or one or more channel conditions.

In an example embodiment, alternatively or in addition to the above-described example embodiments, the method further comprises training the end-to-end ML model by applying a loss comprising a constellation quality metric indicating maximum and minimum distances between two constellation points.

In an example embodiment, alternatively or in addition to the above-described example embodiments, the loss further comprises a binary cross entropy.

An example embodiment of a computer program comprises instructions for causing a radio transmitter device to perform at least the following: obtaining at least two parallel transmission bit streams; and modulating the obtained at least two parallel transmission bit streams for a pilotless multiple-input and multiple-output (MIMO) transmission over a radio channel based on transmission bit stream-specific customized constellation shapes. The customized constellation shapes are generated with an end-to-end machine learning (ML) model representing the radio transmitter device, a radio receiver device and the radio channel. The end-to-end ML model is executable to learn a separate customized constellation shape for each of the at least two parallel transmission bit streams.

An example embodiment of a radio receiver device comprises at least one processor, and at least one memory including computer program code. The at least one memory and the computer program code are configured to, with the at least one processor, cause the radio receiver device at least to perform receiving, over a radio channel, a pilotless multiple-input and multiple-output (MIMO) transmission comprising at least two parallel transmission bit streams. The at least one memory and the computer program code are further configured to, with the at least one processor, cause the radio receiver device at least to perform detecting the received at least two parallel transmission bit streams based on transmission bit stream-specific customized constellation shapes. The customized constellation shapes are generated with an end-to-end machine learning (ML) model representing a radio transmitter device, the radio receiver device and the radio channel. The end-to-end ML model is executable to learn a separate customized constellation shape for each of the at least two parallel transmission bit streams.

In an example embodiment, alternatively or in addition to the above-described example embodiments, the end-to-end ML model is further executable to learn at least one customized constellation shape of the customized constellation shapes via learning at least two transformations mapping from a predefined constellation shape to the respective customized constellation shape.

In an example embodiment, alternatively or in addition to the above-described example embodiments, the end-to-end ML model is further executable to construct a final constellation shape of the respective customized constellation shape as a linear combination of the learned at least two transformations.

In an example embodiment, alternatively or in addition to the above-described example embodiments, the predefined constellation shape comprises a quadrature amplitude modulation (QAM) constellation shape.

In an example embodiment, alternatively or in addition to the above-described example embodiments, the end-to-end ML model is further executable to learn at least one customized constellation shape of the customized constellation shapes via learning a single layer specific transformation mapping from a predefined constellation shape to the respective customized constellation shape as a single fully connected neural network.

In an example embodiment, alternatively or in addition to the above-described example embodiments, the end-to-end ML model is further executable to learn at least one customized constellation shape of the customized constellation shapes directly from a random initialization.

In an example embodiment, alternatively or in addition to the above-described example embodiments, the end-to-end ML model is further executable to refine at least one learned customized constellation shape via contextual information.

In an example embodiment, alternatively or in addition to the above-described example embodiments, the contextual information comprises at least one of an expected signal-to-noise ratio of a client device, a mobility level of a client device, a number of MIMO layers, a number of overlapping client devices, a model size of the radio receiver device, or one or more channel conditions.

In an example embodiment, alternatively or in addition to the above-described example embodiments, the at least one memory and the computer program code are further configured to, with the at least one processor, cause the radio receiver device to perform training the end-to-end ML model by applying a loss comprising a constellation quality metric indicating maximum and minimum distances between two constellation points.

In an example embodiment, alternatively or in addition to the above-described example embodiments, the loss further comprises a binary cross entropy.

An example embodiment of a radio receiver device comprises means for performing causing the radio receiver device to receive, over a radio channel, a pilotless multiple-input and multiple-output (MIMO) transmission comprising at least two parallel transmission bit streams. The means are further configured to perform detecting the received at least two parallel transmission bit streams based on transmission bit stream-specific customized constellation shapes. The customized constellation shapes are generated with an end-to-end machine learning (ML) model representing a radio transmitter device, the radio receiver device and the radio channel. The end-to-end ML model is executable to learn a separate customized constellation shape for each of the at least two parallel transmission bit streams.

In an example embodiment, alternatively or in addition to the above-described example embodiments, the end-to-end ML model is further executable to learn at least one customized constellation shape of the customized constellation shapes via learning at least two transformations mapping from a predefined constellation shape to the respective customized constellation shape.

In an example embodiment, alternatively or in addition to the above-described example embodiments, the end-to-end ML model is further executable to construct a final constellation shape of the respective customized constellation shape as a linear combination of the learned at least two transformations.

In an example embodiment, alternatively or in addition to the above-described example embodiments, the predefined constellation shape comprises a quadrature amplitude modulation (QAM) constellation shape.

In an example embodiment, alternatively or in addition to the above-described example embodiments, the end-to-end ML model is further executable to learn at least one customized constellation shape of the customized constellation shapes via learning a single layer specific transformation mapping from a predefined constellation shape to the respective customized constellation shape as a single fully connected neural network.

In an example embodiment, alternatively or in addition to the above-described example embodiments, the end-to-end ML model is further executable to learn at least one customized constellation shape of the customized constellation shapes directly from a random initialization.

In an example embodiment, alternatively or in addition to the above-described example embodiments, the end-to-end ML model is further executable to refine at least one learned customized constellation shape via contextual information.

In an example embodiment, alternatively or in addition to the above-described example embodiments, the contextual information comprises at least one of an expected signal-to-noise ratio of a client device, a mobility level of a client device, a number of MIMO layers, a number of overlapping client devices, a model size of the radio receiver device, or one or more channel conditions.

In an example embodiment, alternatively or in addition to the above-described example embodiments, the means are further configured to perform training the end-to-end ML model by applying a loss comprising a constellation quality metric indicating maximum and minimum distances between two constellation points.

In an example embodiment, alternatively or in addition to the above-described example embodiments, the loss further comprises a binary cross entropy.

An example embodiment of a method comprises receiving, at a radio receiver device over a radio channel, a pilotless multiple-input and multiple-output (MIMO) transmission comprising at least two parallel transmission bit streams. The method further comprises detecting, by the radio receiver device, the received at least two parallel transmission bit streams based on transmission bit stream-specific customized constellation shapes. The customized constellation shapes are generated with an end-to-end machine learning (ML) model representing a radio transmitter device, the radio receiver device and the radio channel. The end-to-end ML model is executable to learn a separate customized constellation shape for each of the at least two parallel transmission bit streams.

In an example embodiment, alternatively or in addition to the above-described example embodiments, the end-to-end ML model is further executable to learn at least one customized constellation shape of the customized constellation shapes via learning at least two transformations mapping from a predefined constellation shape to the respective customized constellation shape.

In an example embodiment, alternatively or in addition to the above-described example embodiments, the end-to-end ML model is further executable to construct a final constellation shape of the respective customized constellation shape as a linear combination of the learned at least two transformations.

In an example embodiment, alternatively or in addition to the above-described example embodiments, the predefined constellation shape comprises a quadrature amplitude modulation (QAM) constellation shape.

In an example embodiment, alternatively or in addition to the above-described example embodiments, the end-to-end ML model is further executable to learn at least one customized constellation shape of the customized constellation shapes via learning a single layer specific transformation mapping from a predefined constellation shape to the respective customized constellation shape as a single fully connected neural network.

In an example embodiment, alternatively or in addition to the above-described example embodiments, the end-to-end ML model is further executable to learn at least one customized constellation shape of the customized constellation shapes directly from a random initialization.

In an example embodiment, alternatively or in addition to the above-described example embodiments, the end-to-end ML model is further executable to refine at least one learned customized constellation shape via contextual information.

In an example embodiment, alternatively or in addition to the above-described example embodiments, the contextual information comprises at least one of an expected signal-to-noise ratio of a client device, a mobility level of a client device, a number of MIMO layers, a number of overlapping client devices, a model size of the radio receiver device, or one or more channel conditions.

In an example embodiment, alternatively or in addition to the above-described example embodiments, the method further comprises training the end-to-end ML model by applying a loss comprising a constellation quality metric indicating maximum and minimum distances between two constellation points.

In an example embodiment, alternatively or in addition to the above-described example embodiments, the loss further comprises a binary cross entropy.

An example embodiment of a computer program comprises instructions for causing a radio receiver device to perform at least the following: receiving, over a radio channel, a pilotless multiple-input and multiple-output (MIMO) transmission comprising at least two parallel transmission bit streams; and detecting the received at least two parallel transmission bit streams based on transmission bit stream-specific customized constellation shapes. The customized constellation shapes are generated with an end-to-end machine learning (ML) model representing a radio transmitter device, the radio receiver device and the radio channel. The end-to-end ML model being executable to learn a separate customized constellation shape for each of the at least two parallel transmission bit streams.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2A shows an example embodiment of the subject matter described herein illustrating a radio transmitter device;

FIG. 2B shows an example embodiment of the subject matter described herein illustrating a radio receiver device;

FIG. 3 shows an example embodiment of the subject matter described herein illustrating an example implementation of an end-to-end learned MIMO link with two spatial layers;

FIG. 4 shows an example embodiment of the subject matter described herein illustrating an example implementation of a radio receiver device architecture for pilotless detection of MIMO transmissions;

FIG. 5A shows an example embodiment of the subject matter described herein illustrating an example implementation of extracting a constellation shape suitable for pilotless spatial multiplexing;

FIG. 5B shows an example embodiment of the subject matter described herein illustrating an example implementation of learning a constellation transformation as a single fully connected neural network;

FIG. 5C shows an example embodiment of the subject matter described herein illustrating an example implementation of learning constellation points directly and explicitly for two layers;

FIG. 6 shows an example embodiment of the subject matter described herein illustrating an example implementation of a learned constellation shape in which transformations are done based on context information;

FIG. 7 shows an example embodiment of the subject matter described herein illustrating an example implementation of a training architecture and loss calculation;

FIG. 8 shows an example embodiment of the subject matter described herein illustrating a method; and

FIG. 9 shows an example embodiment of the subject matter described herein illustrating another method.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

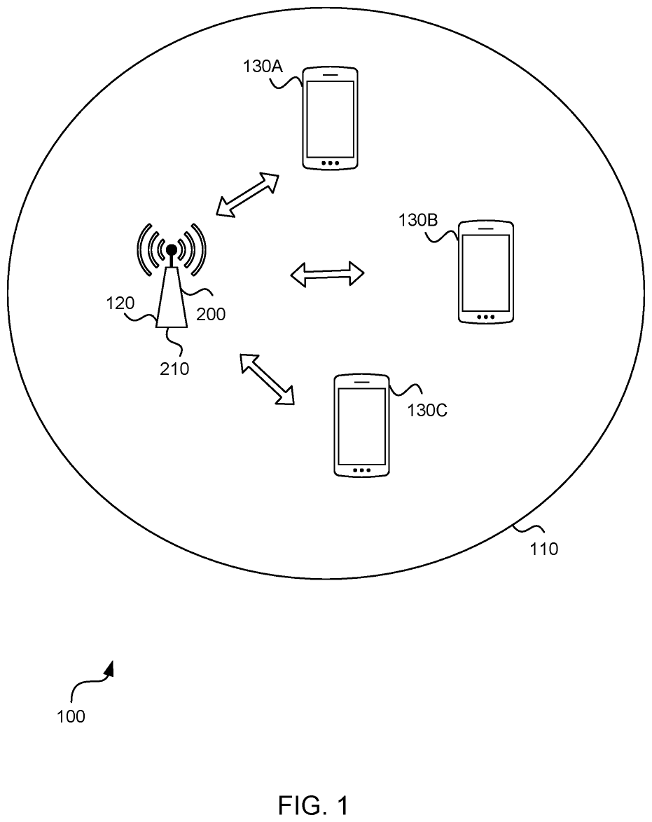

FIG. 1 illustrates an example system 100, where various embodiments of the present disclosure may be implemented. The system 100 may comprise a fifth generation (5G) or sixth generation (6G) communications network 110. An example representation of the system 100 is shown depicting client devices 130A, 130B, 130C, and a network node device 120. At least in some embodiments, the communications network 110 may comprise one or more massive machine-to-machine (M2M) network(s), massive machine type communications (mMTC) network(s), internet of things (IoT) network(s), industrial internet-of-things (IIOT) network(s), enhanced mobile broadband (eMBB) network(s), ultra-reliable low-latency communication (URLLC) network(s), and/or the like. In other words, the communications network 110 may be configured to serve diverse service types and/or use cases, and it may logically be seen as comprising one or more networks.

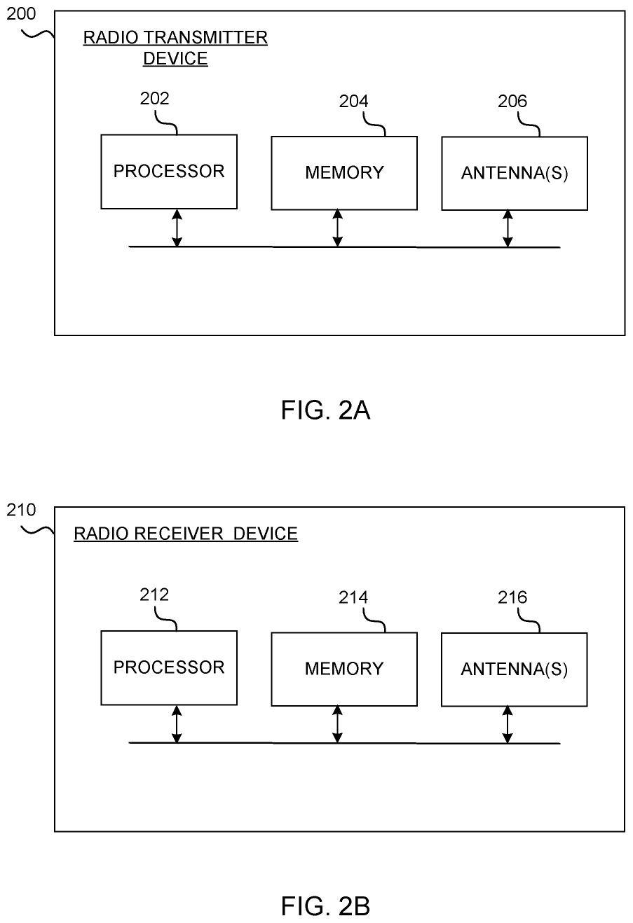

The client devices 130A, 130B, 130C may include, e.g., a mobile phone, a smartphone, a tablet computer, a smart watch, or any hand-held, portable and/or wearable device. The client devices 130A, 130B, 130C may also be referred to as a user equipment (UE). The network node device 120 may be a base station. The base station may include, e.g., a 5G or 6G base station (gNB) or any such device suitable for providing an air interface for client devices to connect to a wireless network via wireless transmissions. The network node device 120 may comprise a radio transmitter device 200 of FIG. 2A and/or a radio receiver device 210 of FIG. 2B.

In the following, various example embodiments will be discussed. At least some of these example embodiments may allow machine learning enhanced pilotless radio transmission with spatial multiplexing.

At least some of these example embodiments may utilize end-to-end machine learning. Herein, the end-to-end machine learning refers to machine learning in which a transmitter and a receiver are trained jointly to communicate over a wireless communications channel. This may be done, e.g., in a supervised manner by considering transmitted information bits as input and received bits as output (which ideally should be equal to the transmitted bits).

At least some of these example embodiments may utilize a DeepRx based radio receiver device. Herein, the term DeepRx refers to a deep fully convolutional neural network (CNN) which, at least in some embodiments, may execute a whole receiver pipeline from a frequency domain signal stream to uncoded bits. In some embodiments, a DeepRx may comprise several residual neural network (ResNet) blocks.

At least some of these example embodiments may allow machine learning to perform pilotless multiple-input and multiple-output (MIMO) transmissions with spatial multiplexing. At least in some embodiments, this may result in an improved throughput over the air since no resources are needed for the transmission of channel estimation pilots. At least some of these example embodiments may allow machine learning such a constellation shape that lends itself to both blind and pilotless detection, and separation of the overlapping spatial streams (i.e., layers).

At least some of these example embodiments may allow a system to be trained by implementing a full MIMO link as a single differentiable model which includes both learned and “fixed” (not-learned) parts. The former may include, e.g., a constellation and a receiver, while the latter may include, e.g., orthogonal frequency-division multiplexing (OFDM) modulation, a channel, a noise source, and time-domain Rx processing. Then, the link may be trained end-to-end with, e.g., supervised training in which the input may include a random message of bits, and the output may include final noisy bit estimates provided by the receiver.

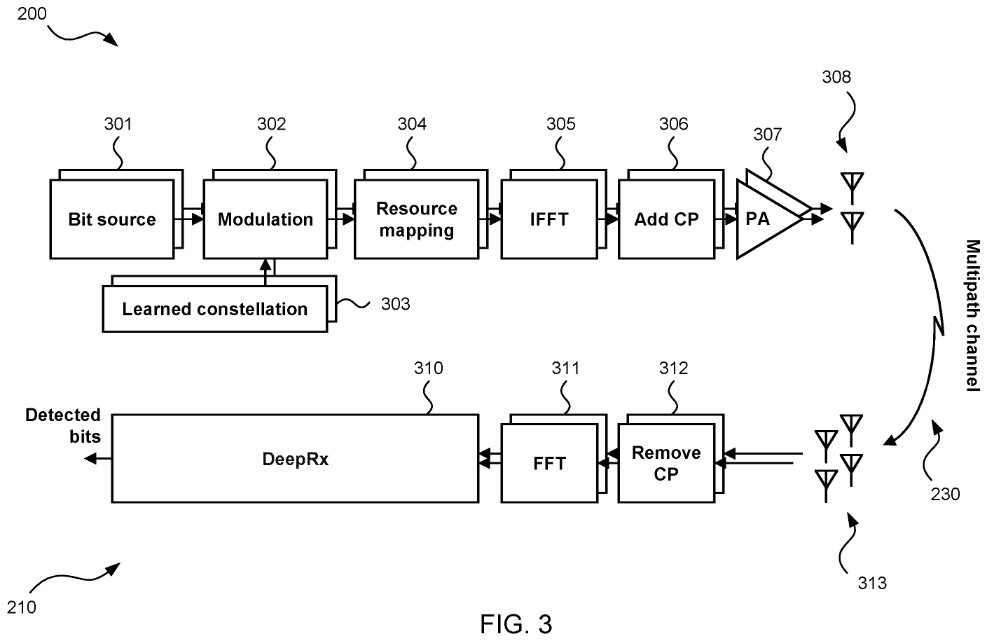

FIG. 3 illustrates an example implementation of an end-to-end learned MIMO link with two spatial layers. More specifically, FIG. 3 illustrates system that comprises the radio transmitter device 200, the radio receiver device 210, and a radio channel 230 (e.g., a multipath radio channel). The radio transmitter device 200 and the radio receiver device 210 are illustrated in terms of functional blocks. The radio transmitter device 200 may include, e.g., a modulation block 302, a resource mapping block 304, an inverse fast Fourier transform (IFFT) block 305, a cyclic prefix (CP) addition block 306, a power amplifier (PA) block 307, and/or transmit antennas 308. The blocks 302-307 may be implemented with, e.g., a processor 202 and a memory 204 of the radio transmitter device 200 shown in FIG. 2A and discussed in more detail below. The radio receiver device 210 may include, e.g., receive antennas 313, a cyclic prefix (CP) removal block 312, a fast Fourier transform (FFT) block 311, and/or a DeepRx-type deep fully convolutional neural network 310. The blocks 310-312 may be implemented with, e.g., a processor 212 and a memory 214 of the radio receiver device 210 shown in FIG. 2B and discussed in more detail below.

The system of FIG. 3 has two transmission layers in which, at the radio transmitter device 200 side, two bit streams 301 may be modulated (block 302) into symbols using learned constellations 303. Since no pilots are being used, the symbols may be mapped (block 304) to all the available resource elements (REs) without having to reserve any REs for pilot overhead. The ensuing RE grid may then be turned into, e.g., an OFDM waveform for transmission over the multipath radio channel 230. Herein, the terms transmission layer and transmission bit stream are used interchangeably.

At the radio receiver device 210 side, the received signal may be OFDM demodulated, after which the actual reception may performed by the DeepRx-type deep fully convolutional neural network 310. At least in some embodiments, the DeepRx-type deep fully convolutional neural network 310 may process a single transmission time interval (TTI)/slot at once. Accordingly, the system of FIG. 3 may operate on a slot by slot basis. Furthermore, in the system of FIG. 3, no raw channel estimate is fed as input to the DeepRx-type deep fully convolutional neural network 310 since the received signal does not contain any pilots. Accordingly, only the received signal may be fed to the DeepRx-type deep fully convolutional neural network 310.

An aspect that facilitates pilotless spatial multiplexing is a learned constellation shape (discussed in more detail below). This may be done by learning separate constellation shapes for each transmission layer so that the system can learn such constellation shapes that facilitate both pilotless layer separation and pilotless detection of bits. It is to be noted that the disclosure applies to any number of transmission layers more than one.

FIG. 2A is a block diagram of the radio transmitter device 200, in accordance with an example embodiment.

The radio transmitter device 200 comprises one or more processors 202 and one or more memories 204 that comprise computer program code. The radio transmitter device 200 may be configured to transmit information to other devices. In one example, the radio transmitter device 200 may transmit signalling information and data in accordance with at least one cellular communication protocol. The radio transmitter device 200 may be configured to provide at least one wireless radio connection, such as for example a 3GPP mobile broadband connection (e.g., 5G or 6G). The radio transmitter device 200 may comprise, or be configured to be coupled to, at least one antenna 206 to transmit radio frequency signals.

Although the radio transmitter device 200 is depicted to include only one processor 202, the radio transmitter device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments, such as an end-to-end machine learning (ML) model discussed in more detail below.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

It is also possible to train one ML model with a specific architecture, then derive another ML model from that using processes such as compilation, pruning, quantization or distillation. The ML model may be executed using any suitable apparatus, for example a CPU, GPU, ASIC, FPGA, compute-in-memory, analog, or digital, or optical apparatus. It is also possible to execute the ML model in an apparatus that combines features from any number of these, for instance digital-optical or analog-digital hybrids. In some examples, weights and required computations in these systems may be programmed to correspond to the ML model. In some examples, the apparatus may be designed and manufactured so as to perform the task defined by the ML model so that the apparatus is configured to perform the task when it is manufactured without the apparatus being programmable as such.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The radio transmitter device 200 may comprise any of various types of digital devices capable of transmitting radio communication in a wireless network. At least in some embodiments, the radio transmitter device 200 may be comprised in a base station, such as a 5G or 6G base station (gNB) or any such device providing an air interface for client devices to connect to the wireless network via wireless transmissions. The radio transmitter device 200 comprises a MIMO capable radio transmitter device.

The at least one memory 204 and the computer program code are configured to, with the at least one processor 202, cause the radio transmitter device 200 to at least perform obtaining at least two parallel transmission bit streams.

The at least one memory 204 and the computer program code are further configured to, with the at least one processor 202, cause the radio transmitter device 200 at least to perform modulating the obtained at least two parallel transmission bit streams for a pilotless MIMO transmission over a radio channel 230 based on transmission bit stream-specific customized constellation shapes. For example, the modulation may comprise (OFDM) based modulation. The customized constellation shapes are generated with an end-to-end ML model representing the radio transmitter device 200, a radio receiver device 210 and the radio channel 230. The end-to-end ML model is executable to learn a separate customized constellation shape for each of the at least two parallel transmission bit streams.

At least in some embodiments, the end-to-end ML model may further be executable to learn at least one customized constellation shape of the customized constellation shapes via learning at least two transformations mapping from a predefined constellation shape to the respective customized constellation shape. For example, such a predefined constellation shape may comprise a quadrature amplitude modulation (QAM) constellation shape. Furthermore, the end-to-end ML model may further be executable to construct a final constellation shape of the respective customized constellation shape as a linear combination of the learned at least two transformations.

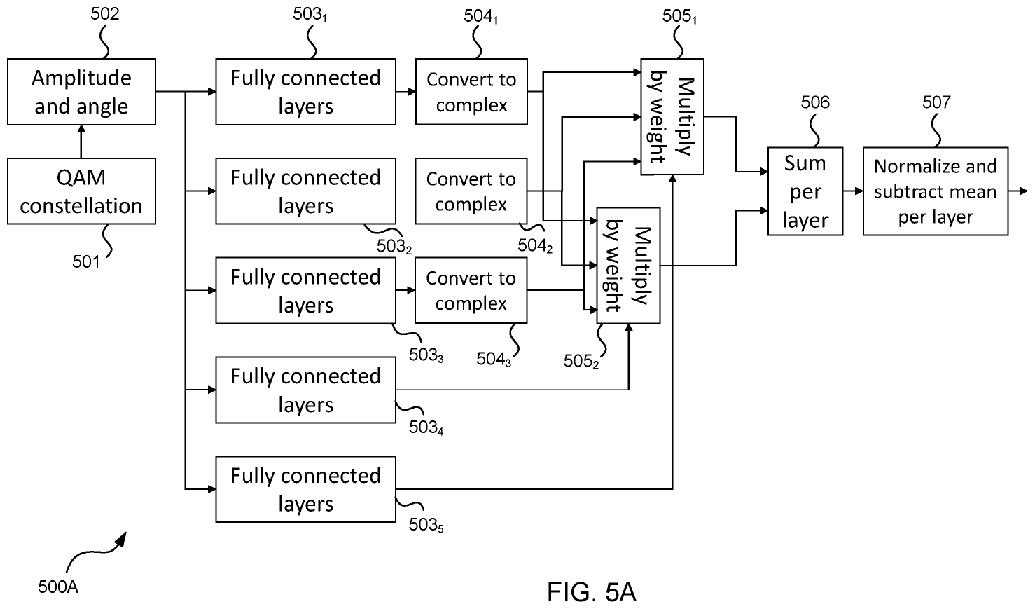

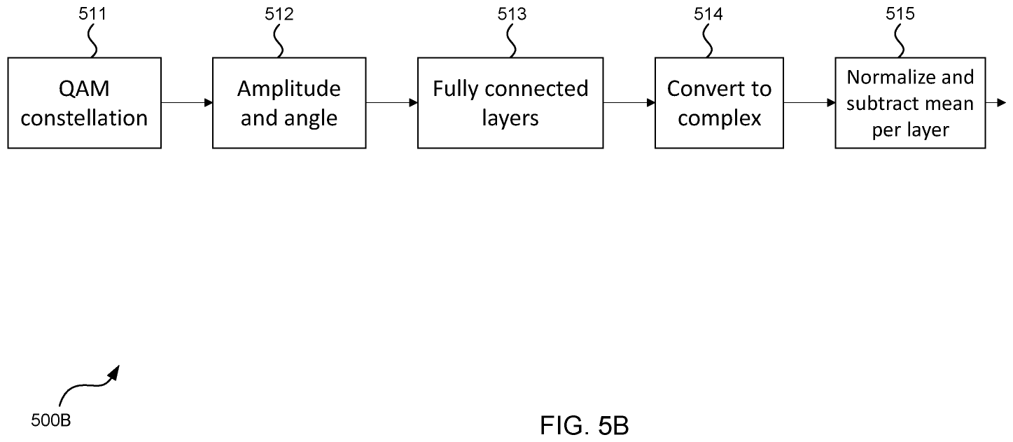

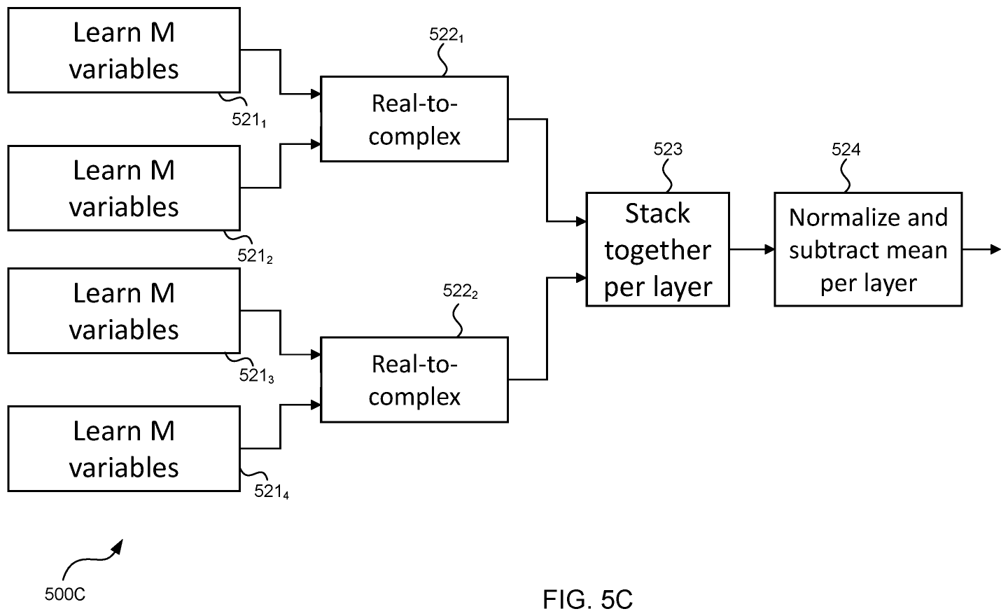

Diagram 500A of FIG. 5A illustrates an example implementation of extracting a constellation shape suitable for pilotless spatial multiplexing. This process may be repeated for each transmission layer to get separate constellation for the layers. Diagram 500A includes a QAM constellation 501, an amplitude and angle determination block 502, fully connected layers 503₁-503₅, convert to complex-value blocks 504₁-504₃, multiply by weight blocks 505₁-505₂, a sum per layer block 506, and a normalize and subtract mean per layer block 507.

The example approach of FIG. 5A is based on learning a predefined number of transformations, denoted by C, and constructing the final constellation shape as a linear combination of these transformations (in FIG. 5A, C=3). These transformations may be performed, e.g., for amplitudes and angles 502 of conventional QAM constellations 501, and the resulting constellation may be converted back to a complex-valued representation at 504₁-504₃ and normalized at 507. The transformations may be shared between all transmission layers, whereas the weighting factors per transformation may be learned separately per transmission layer (in the example of 5A there are hence five fully connected NNs 503₁-503₅ since there are three transformations and two transmission layers).

To further clarify the embodiment of 5A, the inference of the learned constellation is described next. Denoting the amplitude and angle of the i^{th} QAM constellation point by

$${c}_{i}^{QAM} ∈ {ℝ}^{2 \times 1} ,$$

it may be transformed by a fully connected NN, e.g., as follows:

$${c}_{c , i}^{NN} = {f}_{c} ( {c}_{i}^{QAM} ) ∈ {ℝ}^{2 \times 1} ,$$

in which f_{c}(⋅) denotes a fully connected NN for the c^{th} transformation. In total, there are C such fully connected NNS, resulting in C transformed constellation points (in the example embodiment C=3). The transformed constellation points may then be converted to a complex-valued representation, after which they may be collected to a vector

$${c}_{i}^{NN} ∈ {ℂ}^{C \times 1} .$$

Final per-transmission layer constellations may then be obtained, e.g., by first calculating weighting factors for the individual transformations, e.g., as follows:

$${w}_{l , i} = {g}_{1} ( {c}_{i}^{QAM} ) ∈ {ℝ}^{C \times 1} ,$$

in which gₗ(⋅) denotes a fully connected NN for the l^{th} transmission layer, such that each transmission layer has its own NN. The final transformed constellation point for the l^{th} transmission layer may then be obtained, e.g., by:

$${c}_{l , i}^{TF} = {w}_{l , i}^{T} {c}_{i}^{NN}$$

After this, all the constellation points may be collected by repeating this process over i, resulting in a full constellation for each transmission layer, denoted by

$${c}_{l}^{TF} ∈ {ℂ}^{M \times 1} ,$$

where M is the size of the constellation. This may then be normalized and centered to obtain the final constellation, e.g., as follows:

$${c}_{l} = \frac{{c}_{l}^{TF} - \frac{1}{M} {\sum }_{i = 1}^{M} {c}_{l , i}^{TF}}{\sqrt{\frac{1}{M} {\sum }_{i = 1}^{M} {\vert {c}_{l , i}^{TF} \vert}^{2} - {\vert \frac{1}{M} {\sum }_{i = 1}^{M} {c}_{l , i}^{TF} \vert}^{2}}}$$

At least in some embodiments, the end-to-end ML model may further be executable to learn at least one customized constellation shape of the customized constellation shapes via learning a single layer specific transformation mapping (i.e., a single transformation mapping for each layer) from a predefined constellation shape to the respective customized constellation shape as a single fully connected neural network.

Diagram 500B of FIG. 5B illustrates an example implementation of learning a constellation transformation as a single fully connected neural network. Diagram 500B includes a QAM constellation 511, an amplitude and angle determination block 512, fully connected layers 513, a convert to complex-value block 514, and a normalize and subtract mean per layer block 515. In this example embodiment, a QAM constellation 511 may be transformed with a single fully connected NN 513, each layer having its own separate transformation NN.

At least in some embodiments, the end-to-end ML model may further be executable to learn at least one customized constellation shape of the customized constellation shapes directly from random initialization.

Diagram 500C of FIG. 5C illustrates illustrating an example implementation of learning constellation points directly (and explicitly) for two layers. Diagram 500C includes blocks 521₁-521₄ for learning M variables, real-values to complex-values conversion blocks 522₁-522₂, a stack together per layer block 523, and a normalize and subtract mean per layer block 524. In the example embodiment of FIG. 5C, learning the constellation points directly and explicitly means that the real and imaginary values of the constellation for each layer may be specified as learned variables 521₁-521₄. The output may be centered and normalized at 524, after which the resulting constellation shape may be utilized.

At least in some embodiments, the end-to-end ML model may further be executable to refine at least one learned customized constellation shape via contextual information. For example, the contextual information may comprise an expected signal-to-noise ratio (SNR) of a client device 130A, 130B, 130C, a mobility level of a client device 130A, 130B, 130C, a number of MIMO layers, a number of overlapping client devices 130A, 130B, 130C, a model size of the radio receiver device 210, and/or one or more channel conditions.

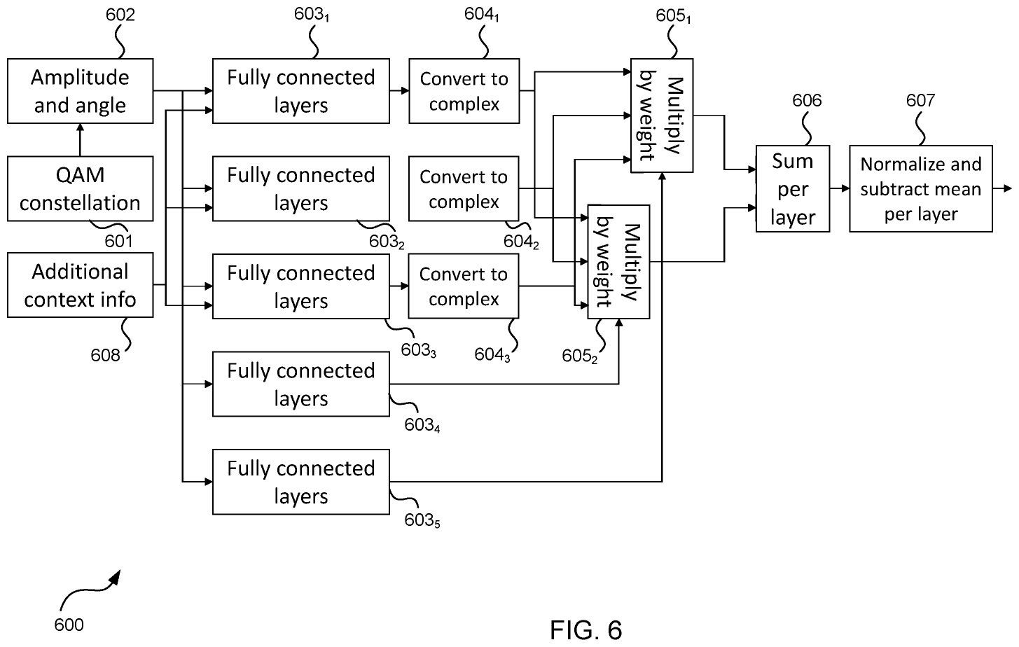

Diagram 600 of FIG. 6 illustrates an example implementation of a learned constellation shape in which transformations are done based on contextual information. Diagram 600 includes a QAM constellation 601, an amplitude and angle determination block 602, fully connected layers 603₁-603₅, convert to complex-value blocks 604₁-604₃, multiply by weight blocks 605₁-605₂, a sum per layer block 606, a normalize and subtract mean per layer block 607, and the additional contextual information 608. For example, the learned constellations may be refined by utilizing the contextual information 608 when determining the constellation shape, as depicted in FIG. 6. For example, this contextual information 608 may be amended to the constellation 601 amplitude and angle 602 which form the transformation NN input vector. It is to be noted that, at least in some embodiments, this contextual information 608 may not need to be fed to the NNs used for calculating the weight of each transformation NN output.

At least in some embodiments, the at least one memory 204 and the computer program code may further be configured to, with the at least one processor 202, cause the radio transmitter device 200 to perform training the end-to-end ML model by applying a loss comprising a constellation quality metric indicating maximum and minimum distances between two constellation points. At least in some embodiments, the loss may further comprise binary cross entropy.

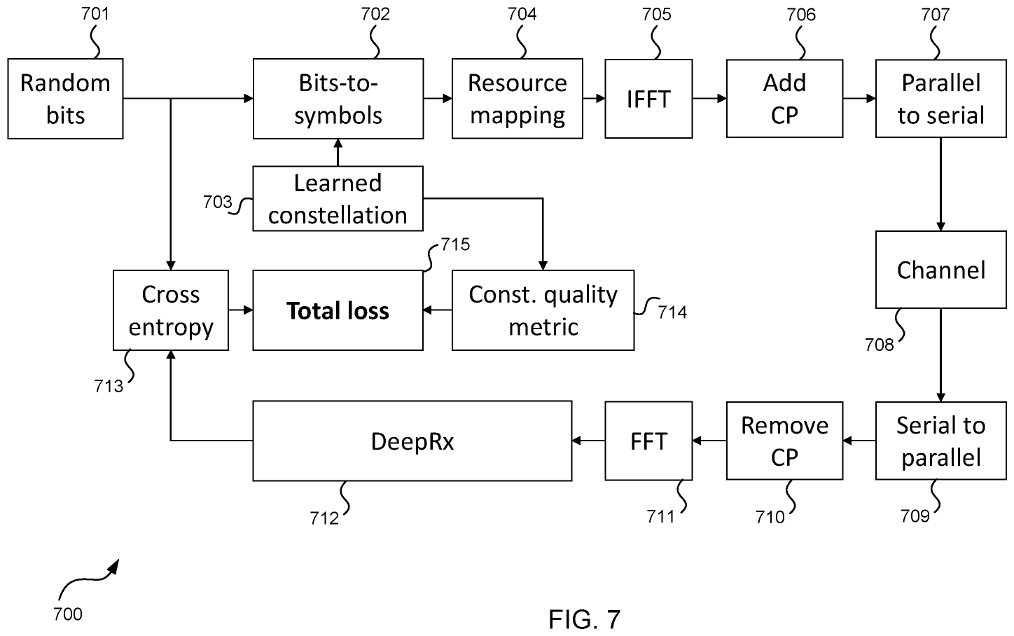

Diagram 700 of FIG. 7 illustrates an example implementation of a training architecture and loss calculation. Diagram 700 includes a random bits block 701, a bits to symbols conversion block 702, a learned constellation block 703, a resource mapping block 704, an IFFT block 705, a CP addition block 706, a parallel to serial conversion block 707, a channel 708, a serial to parallel conversion block 709, a CP removal block 710, an FFT block 711, a DeepRx block 712, a binary cross entropy block 713, a constellation quality metric 714, and a total loss block 715. The total loss 715 may be constructed from two terms: (i) the binary cross entropy (CE) 713 which may ensure that the system learns to maximize the throughput, and (ii) the constellation quality metric 714, the purpose of which is to ensure a more efficient model convergence.

The cross entropy 713 may be calculated, e.g., as follows:

$${CE}_{q} ( θ ) = - \frac{1}{{W}_{q}} {\sum }_{i = 0}^{{W}_{q} - 1} ( {b}_{iq} log ( {\hat{b}}_{iq} ) + ( 1 - {b}_{iq} ) log ( 1 - {\hat{b}}_{iq} ) )$$

in which q denotes a sample index within a batch, i denotes a bit index within a slot, b_{iq} denotes a transmitted bit 701, \hat{b}_{iq} denotes a bit estimated by the receiver, and W_{q} denotes a total number of transmitted bits within a TTI. Moreover, θ denotes a set of all trainable parameters, including the constellation 703 and the DeepRx 712 model weights.

The constellation quality metric 714 may be defined, e.g., as follows:

$${D}_{q} ( θ ) = ReLu ( ln ( mean ( \frac{{d}_{l , ma x} ( θ )}{{d}_{l , m i n} ( θ )} ) ) - B )$$

in which d_{l,max}(θ) and d_{l,min}(θ) denote the maximum and minimum distances between two constellation points for the l^{th} layer, respectively, B denotes a predefined bias term, and ReLu denotes a rectified linear unit activation function (it renders all negative values to zero). Moreover, the mean may be calculated over the ratios of different layers. The effect of this loss term is to introduce a penalty for such constellations which have very small distances between the constellation points of a single layer, which will result in a reduced likelihood of getting stuck in local minimae.

With these, the total loss function 715 becomes:

$${L}_{q} ( θ ) = {CE}_{q} ( θ ) + {WD}_{q} ( θ )$$

in which W denotes a predefined weight for the constellation loss term. During training the loss may be summed over several batches.

At least in some embodiments, the training may be carried out with, e.g., at least some of the following steps:
1. Initialize trainable weights of the complete NN architecture, including the constellation parameters/transformations and the DeepRx based receiver. This may be done, e.g., with random initialization. Collect all the trainable weights into a vector θ.
2. Generate a batch of random transmit data. The choice of batch size may be done, e.g., based on available memory or observed training performance.
3. Feed the batch of data through the complete end-to-end model, including the transmitter, channel model, and the DeepRx. This is referred to as a model forward pass.
4. Calculate the sum loss L for the batch, as described in FIG. 7 and discussed above.
5. Calculate the gradient of the loss L with respect to the trainable network parameters θ (this is a so-called backward pass) and update the parameters with a stochastic gradient descent (SGD) rule, using a predefined learning rate. In this example embodiment, e.g., a so-called Adam optimizer may be used, which is an SGD variant for neural networks.
6. If a predefined stop condition is met, terminate the training. Otherwise go back to step 2. The stop condition may include, e.g., a predefined amount of iterations (this is the condition used in this example embodiment), but it may also include a given loss value or some other performance criterion.

Alternatively, e.g., if training in the field, instead of this type of supervised learning approach, e.g., reinforcement learning (RL) may be utilized. Such on-field training with RL may focus on optimizing the constellation shape under fixed receiver model weights, or it may also involve some finetuning of the radio receiver device 210.

FIG. 2B is a block diagram of the radio receiver device 210, in accordance with an example embodiment.

The radio receiver device 210 comprises one or more processors 212 and one or more memories 214 that comprise computer program code. The radio receiver device 210 may be configured to receive information from other devices. In one example, the radio receiver device 210 may receive signalling information and data in accordance with at least one cellular communication protocol. The radio receiver device 210 may be configured to provide at least one wireless radio connection, such as for example a 3GPP mobile broadband connection (e.g., 5G). The radio receiver device 210 may comprise, or be configured to be coupled to, at least one antenna 216 to receive radio frequency signals.

Although the radio receiver device 210 is depicted to include only one processor 212, the radio receiver device 210 may include more processors. In an embodiment, the memory 214 is capable of storing instructions, such as an operating system and/or various applications. Furthermore, the memory 214 may include a storage that may be used to store, e.g., at least some of the information and data used in the disclosed embodiments, such as the end-to-end machine learning (ML) model discussed in more detail above.

Furthermore, the processor 212 is capable of executing the stored instructions. In an embodiment, the processor 212 may be embodied as a multi-core processor, a single core processor, or a combination of one or more multi-core processors and one or more single core processors. For example, the processor 212 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network chip, an artificial intelligence (AI) accelerator, or the like. In an embodiment, the processor 212 may be configured to execute hard-coded functionality. In an embodiment, the processor 212 is embodied as an executor of software instructions, wherein the instructions may specifically configure the processor 212 to perform the algorithms and/or operations described herein when the instructions are executed.

The memory 214 may be embodied as one or more volatile memory devices, one or more non-volatile memory devices, and/or a combination of one or more volatile memory devices and non-volatile memory devices. For example, the memory 214 may be embodied as semiconductor memories (such as mask ROM, PROM (programmable ROM), EPROM (erasable PROM), flash ROM, RAM (random access memory), etc.).

The radio receiver device 210 may comprise any of various types of digital devices capable of receiving radio communication in a wireless network. At least in some embodiments, the radio receiver device 210 may be comprised in a base station, such as a 5G or 6G base station (gNB) or any such device providing an air interface for client devices to connect to the wireless network via wireless transmissions. The radio receiver device 210 comprises a MIMO capable radio receiver device.

The at least one memory 214 and the computer program code are configured to, with the at least one processor 212, cause the radio receiver device 210 to at least perform receiving, over a radio channel 230, a pilotless MIMO transmission comprising at least two parallel transmission bit streams.

The at least one memory 214 and the computer program code are further configured to, with the at least one processor 212, cause the radio receiver device 210 at least to perform detecting the received at least two parallel transmission bit streams based on transmission bit stream-specific customized constellation shapes.

As discussed above in more detail, the customized constellation shapes are generated with an end-to-end ML model representing a radio transmitter device 200, the radio receiver device 210 and the radio channel 230. The end-to-end ML model is executable to learn a separate customized constellation shape for each of the at least two parallel transmission bit streams.

At least in some embodiments, the at least one memory 214 and the computer program code may further be configured to, with the at least one processor 212, cause the radio receiver device 210 to perform training the end-to-end ML model by applying a loss comprising a constellation quality metric indicating maximum and minimum distances between two constellation points.

Further features of the radio receiver device 210 directly result from the functionalities and parameters of the radio transmitter device 200 and thus are not repeated here.

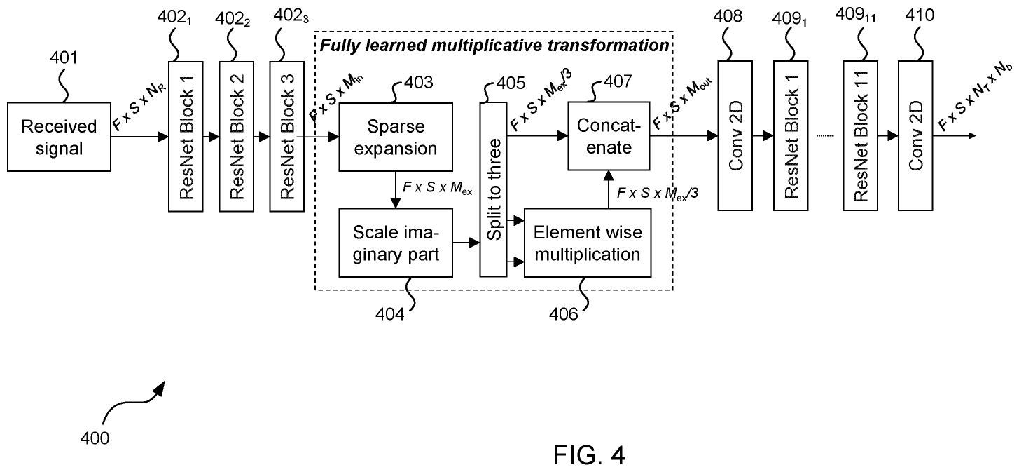

FIG. 4 illustrates an example implementation of a radio receiver device architecture 400 for pilotless detection of MIMO transmissions. The example implementation of the radio receiver device architecture 400 includes three ResNet blocks 402₁-402₃ into which a received signal 401 is fed, a sparse expansion block 403, an imaginary part scaling block 404, a split to three block 405, an element wise multiplication block 406, a concatenation block 407, a two-dimensional convolution (Conv2D) block 408, eleven more ResNet blocks 409₁-409₁₁, and another Conv2D block 410. The purpose of the three ResNet blocks 402₁-402₃ is to extract features from the input data 401, spread along the channel dimension. After this, the blocks 403-407 included in the multiplicative transformation are designed to learn to multiply channels with each other. The final eleven ResNet blocks 409₁-409₁₁ will then extract the bit estimates.

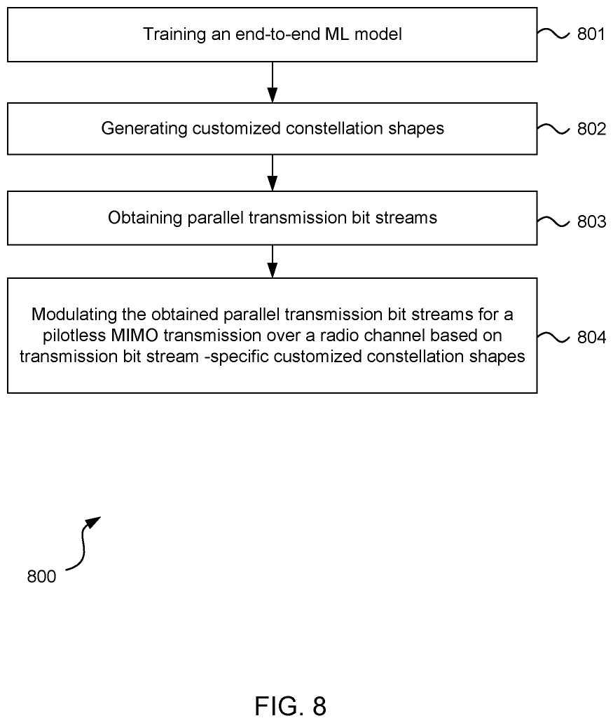

FIG. 8 illustrates an example flow chart of a method 800, in accordance with an example embodiment.

At optional operation 801, the radio transmitter device 200 may train the end-to-end ML model representing the radio transmitter device 200, the radio receiver device 210 and the radio channel 230 by applying a loss comprising a constellation quality metric indicating maximum and minimum distances between two constellation points. As discussed above in more detail, the end-to-end ML model is executable to learn a separate customized constellation shape for each of the at least two parallel transmission bit streams.

At operation 802, customized constellation shapes are generated with the end-to-end ML model.

At operation 803, the radio transmitter device 200 obtains at least two parallel transmission bit streams.

At operation 804, the radio transmitter device 200 modulates the obtained at least two parallel transmission bit streams for a pilotless MIMO transmission over a radio channel based on transmission bit stream-specific customized constellation shapes.

The method 800 may be performed by the radio transmitter device 200 of FIG. 2A. The operations 801-804 can, for example, be performed by the at least one processor 202 and the at least one memory 204. Further features of the method 800 directly result from the functionalities and parameters of the radio transmitter device 200, and thus are not repeated here. The method 800 can be performed by computer program(s).

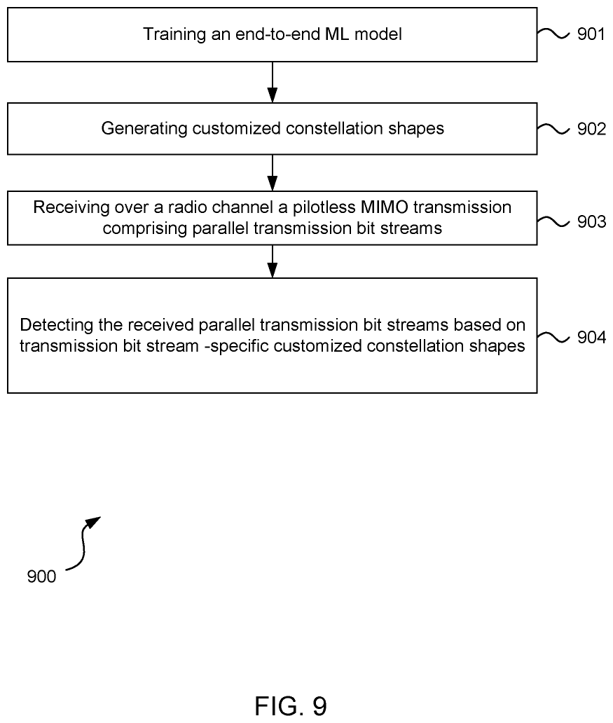

FIG. 9 illustrates an example flow chart of a method 900, in accordance with an example embodiment.

At optional operation 901, the radio receiver device 210 may train the end-to-end ML model representing the radio transmitter device 200, the radio receiver device 210 and the radio channel 230 by applying a loss comprising a constellation quality metric indicating maximum and minimum distances between two constellation points. As discussed above in more detail, the end-to-end ML model is executable to learn a separate customized constellation shape for each of the at least two parallel transmission bit streams.

At operation 902, customized constellation shapes are generated with the end-to-end ML model.

At operation 903, the radio receiver device 210 receives over the radio channel 230 a pilotless MIMO transmission comprising at least two parallel transmission bit streams.

At operation 904, the radio receiver device 210 detects the received at least two parallel transmission bit streams based on transmission bit stream-specific customized constellation shapes.

The method 900 may be performed by the radio receiver device 210 of FIG. 2B. The operations 901-904 can, for example, be performed by the at least one processor 212 and the at least one memory 214. Further features of the method 900 directly result from the functionalities and parameters of the radio receiver device 210, and thus are not repeated here. The method 900 can be performed by computer program(s).

At least some of the embodiments described herein may allow defining neural network-based trainable constellation transformations. These may be used to learn the mapping from a predefined constellation shape to a shape that facilitates pilotless detection under spatial multiplexing.

At least some of the embodiments described herein may allow a loss function based on a distance of individual constellation points, which may stabilize the training process for pilotless MIMO links.

At least some of the embodiments described herein may allow feeding additional inputs to the constellation based on, e.g., client device history or context information. This means that the learned constellation may depend on different factors, such as a signal-to-noise ratio (SNR), client device mobility, a number of overlapping client devices, channel conditions, and/or the like. Input may include a floating-point value when applicable, thereby allowing for seamless adaptation.

Accordingly, at least some of the embodiments described herein may allow improved spectral efficiency due to pilotless operation.

Accordingly, at least some of the embodiments described herein may allow faster convergence during training.

The radio transmitter device 200 may comprise means for performing at least one method described herein. In one example, the means may comprise the at least one processor 202, and the at least one memory 204 including program code configured to, when executed by the at least one processor, cause the radio transmitter device 200 to perform the method.

The radio receiver device 210 may comprise means for performing at least one method described herein. In one example, the means may comprise the at least one processor 212, and the at least one memory 214 including program code configured to, when executed by the at least one processor, cause the radio receiver device 210 to perform the method.

The functionality described herein can be performed, at least in part, by one or more computer program product components such as software components. According to an embodiment, the radio transmitter device 200 and/or the radio receiver device 210 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A radio transmitter device, comprising:
at least one processor; and
at least one memory including computer program code;
the at least one memory and the computer program code configured to, with the at least one processor, cause the radio transmitter device at least to perform:
obtaining at least two parallel transmission bit streams; and
modulating the obtained at least two parallel transmission bit streams for a pilotless multiple-input and multiple-output, MIMO, transmission over a radio channel based on transmission bit stream-specific customized constellation shapes, the customized constellation shapes generated with an end-to-end machine learning, ML, model representing the radio transmitter device, a radio receiver device and the radio channel, and the end-to-end ML model being executable to learn a separate customized constellation shape for each of the at least two parallel transmission bit streams.

2. The radio transmitter device according to claim 1, wherein the end-to-end ML model is further executable to learn at least one customized constellation shape of the customized constellation shapes via learning at least two transformations mapping from a predefined constellation shape to the respective customized constellation shape.

3. The radio transmitter device according to claim 2, wherein the end-to-end ML model is further executable to construct a final constellation shape of the respective customized constellation shape as a linear combination of the learned at least two transformations.

4. The radio transmitter device according to claim 2, wherein the predefined constellation shape comprises a quadrature amplitude modulation, QAM, constellation shape.

5. The radio transmitter device according to claim 1, wherein the end-to-end ML model is further executable to learn at least one customized constellation shape of the customized constellation shapes via learning a single layer specific transformation mapping from a predefined constellation shape to the respective customized constellation shape as a single fully connected neural network.

6. The radio transmitter device according to claim 1, wherein the end-to-end ML model is further executable to learn at least one customized constellation shape of the customized constellation shapes directly from a random initialization.

7. The radio transmitter device according to claim 1, wherein the end-to-end ML model is further executable to refine at least one learned customized constellation shape via contextual information.

8. The radio transmitter device according to claim 7, wherein the contextual information comprises at least one of an expected signal-to-noise ratio of a client device, a mobility level of a client device, a number of MIMO layers, a number of overlapping client devices, a model size of the radio receiver device, or one or more channel conditions.

9. The radio transmitter device according to claim 1, wherein the at least one memory and the computer program code are further configured to, with the at least one processor, cause the radio transmitter device to perform training the end-to-end ML model by applying a loss comprising a constellation quality metric indicating maximum and minimum distances between two constellation points.

10. The radio transmitter device according to claim 9, wherein the loss further comprises a binary cross entropy.

11. A method, comprising:
obtaining, at a radio transmitter device, at least two parallel transmission bit streams; and
modulating, by the radio transmitter device, the obtained at least two parallel transmission bit streams for a pilotless multiple-input and multiple-output, MIMO, transmission over a radio channel based on transmission bit stream-specific customized constellation shapes, the customized constellation shapes generated with an end-to-end machine learning, ML, model representing the radio transmitter device, a radio receiver device and the radio channel, and the end-to-end ML model being executable to learn a separate customized constellation shape for each of the at least two parallel transmission bit streams.

12. A computer program comprising instructions for causing a radio transmitter device to:
obtain at least two parallel transmission bit streams; and
modulate the obtained at least two parallel transmission bit streams for a pilotless multiple-input and multiple-output, MIMO, transmission over a radio channel based on transmission bit stream-specific customized constellation shapes, the customized constellation shapes generated with an end-to-end machine learning, ML, model representing the radio transmitter device, a radio receiver device and the radio channel, and the end-to-end ML model being executable to learn a separate customized constellation shape for each of the at least two parallel transmission bit streams.

13-15. (canceled)

16. The method according to claim 11, wherein the end-to-end ML model is further executable to learn at least one customized constellation shape of the customized constellation shapes via learning at least two transformations mapping from a predefined constellation shape to the respective customized constellation shape.

17. The method according to claim 16, wherein the end-to-end ML model is further executable to construct a final constellation shape of the respective customized constellation shape as a linear combination of the learned at least two transformations.

18. The method according to claim 16, wherein the predefined constellation shape comprises a quadrature amplitude modulation, QAM, constellation shape.

19. The method according to claim 11, wherein the end-to-end ML model is further executable to learn at least one customized constellation shape of the customized constellation shapes via learning a single layer specific transformation mapping from a predefined constellation shape to the respective customized constellation shape as a single fully connected neural network.

20. The method according to claim 11, wherein the end-to-end ML model is further executable to learn at least one customized constellation shape of the customized constellation shapes directly from a random initialization.

21. The method according to claim 11, wherein the end-to-end ML model is further executable to refine at least one learned customized constellation shape via contextual information.

22. The method according to claim 21, wherein the contextual information comprises at least one of an expected signal-to-noise ratio of a client device, a mobility level of a client device, a number of MIMO layers, a number of overlapping client devices, a model size of the radio receiver device, or one or more channel conditions.

23. The method according to claim 11, further comprising training the end-to-end ML model by applying a loss comprising a constellation quality metric indicating maximum and minimum distances between two constellation points.
